(19) United States
(12) Patent Application Publication
(10) Pub. No.: US 2005/0267844 A1
(43) Pub. Date: Dec. 1, 2005

(54) Secure electronic file delivery system

(76) Inventors: Michel Gallant, Nepean (CA); Lawrence Tarof, Kanata (CA)

Correspondence Address: Lawrence Tarof, 4 Grengold Way, Kanata, ON, K2T 1C8, CA

(21) Appl. No.: 10/942,076

(22) Filed: Sep. 16, 2004

Related U.S. Application Data
(60) Provisional application No. 60/503,474, filed on Sep. 17, 2003.

(51) Int. Cl. H04L 9/00

(52) U.S. Cl. 705/51

(57) ABSTRACT

A method of packaging and securing computer data permitting the distribution of the secured data electronically from an originating party to any number of recipient parties via any of a variety of data transfer methods including: email, electronic network file distribution ftp, http and other Internet protocols, as well as electronic fixed media CD-ROM, DVD and HD. In order to secure computer data, the electronic data files are packaged as resources, along with an electronic signature, into an executable container file. The container file includes executable instructions for verifying the electronic signature to ensure integrity of the entire container file. Access to individual contents within the executable container file is optionally protected using any of the various types of key access, such as standard cryptographic encapsulations.

### FIELD OF THE INVENTION

The invention relates the authentication systems for electronic files. More specifically, the invention relates to a system for delivering secure electronic file attachments.

### BACKGROUND OF THE INVENTION

The distribution of electronic computer data is currently achieved using a wide variety of methods, involving any of: email, portable non-volatile storage media and Internet downloading to name a few. It is not uncommon that individuals and corporations rely heavily on the authenticity and accuracy of such data and consequently there is a need to ensure that such data is not corrupted or forged. Worse still, viruses and other computer programs having illicit purpose are often disguised as useful programs or even useful computer data files. Thus, there is need to ensure that computer data and computer programs are authentic. The prior art often addresses this type of issue in the context of securing email.

For example, in U.S. Pat. No. 6,571,334 by Feldbau et al. a secure electronic mail delivery system is described. This system is focused on providing the sender with evidence that can be used to prove both a dispatch and the contents of the dispatch. In use, a dispatch from the sender to a recipient is first sent to a third party. The third party packages the data in a way that prevents tampering and provides a secure timestamp on the package. The package is then sent to the receiver and, optionally, a copy is sent to the sender as well. Thus, the receiver is provided a message that is secure.

A variety of similar systems and procedures similar to the prior art of Feldbau exist in which electronic mail is sent to a trusted intermediate party and then to the recipient. Clearly, this leaves the trusted intermediate party as an obvious target for hackers. Additionally, as the sender or the recipient of secure electronic mail, the question of the integrity of the trusted intermediate party is suspect. Further, in the event that the trusted intermediate party ceases operations then a new secure trusted intermediate party will have to be found. In many circumstances, this type of disruption is highly detrimental to business.

Microsoft has demonstrated another method of providing files in a secure manner. Specifically, cabinet files having a digital signature are provided to a user absent authentication by a trusted intermediate party. The user receives and activates a cabinet file. The cabinet file provides data in the form of an electronic signature to an external executable file provided with the Windows Tm operating system. The external executable file queries the Microsoft Windows Tm operating system crypto API to verify the authenticity of the electronic signature and thereby verify the authenticity of the cabinet file. If the cabinet file has been tampered with then the user is informed of the tampering. If no tampering is detected then the user is given access to files thereby permitting the user to update their files safely. It should be noted that the Microsoft cabinet file need not be provided as an email attachment. Indeed it is optionally provided via downloading over the Internet or via a non-volatile storage medium such as a CD-Rom.

It would be beneficial to provide electronic mail with attachments in a secure fashion over public networks without relying on a third party to provide security while also supporting a wide variety of computing platforms and operating systems.

### SUMMARY OF INVENTION

The invention teaches a method of creating a container file and providing the container file from a sender to a recipient, the method comprising:
providing a computer associated with the sender;
using the computer associated with the sender to encode at least a file to provide an encoded file, the encoded file for when accessed
executing instructions provided with the encoded file, the instructions for verifying that a portion of data within the encoded file has not been modified;
upon successful verification, executing at least an instruction from a first list of instructions; and;
upon unsuccessful verification, executing at least an instruction from a second list of instructions; and,
providing the encoded file to at least a recipient.

Further, the invention describes a method of creating a container file and providing the container file from a sender to a recipient, the method comprising:
providing a computer associated with the sender;
using the computer associated with the sender to encode at least a file to provide an encoded file, each file of the at least a file having a security clearance value associated therewith, the encoded file for when accessed
receiving a secure electronic data capsule associated with a security clearance value of a user;
executing instructions providing with the encoded file, the instructions for verifying that a portion of data within the encoded file has not been modified;
upon successful verification, executing instructions for a first list of instructions; and;
upon unsuccessful verification, executing instructions from a second list of instructions; and,
providing the encoded file to at least a recipient.

### BRIEF DESCRIPTION OF THE DRAWINGS

FIG. 1 is a block diagram illustrative of a method consistent with a first embodiment of the invention supporting a single recipient; and,

FIG. 2 is a diagram illustrative of a method consistent with a second embodiment of the invention supporting a multiple recipients having differing levels of security clearance.

### DETAILED DESCRIPTION OF THE INVENTION

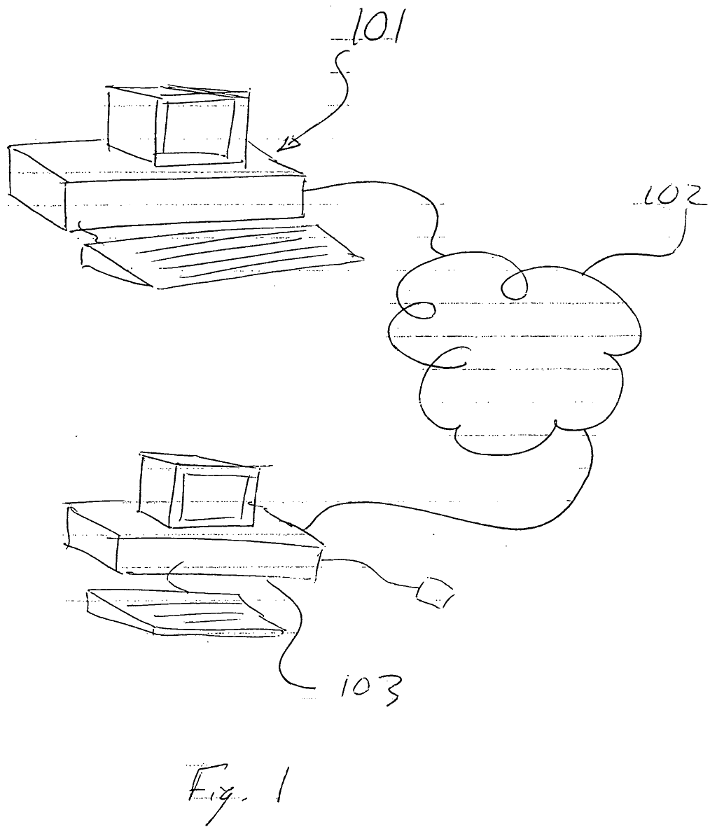

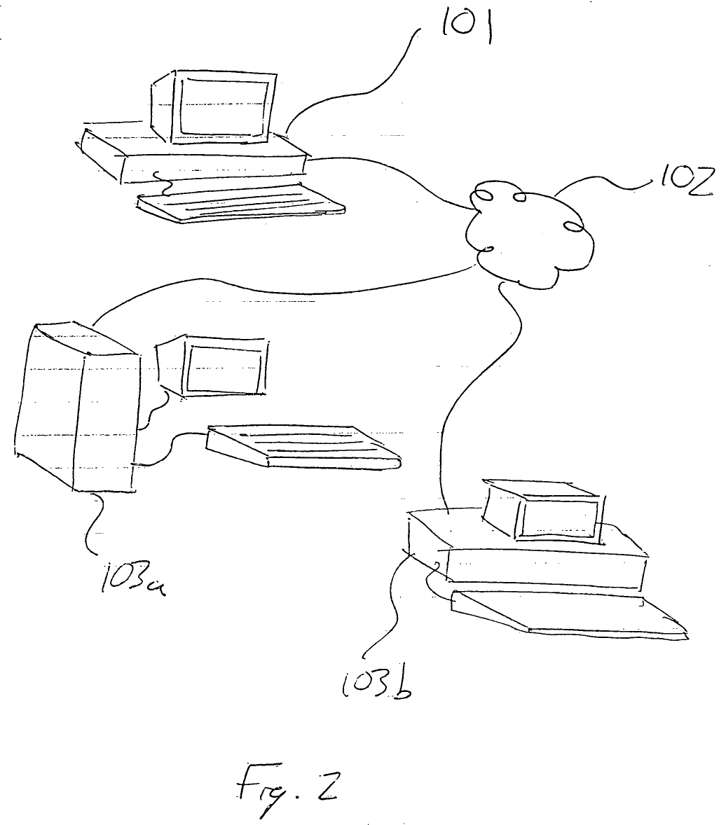

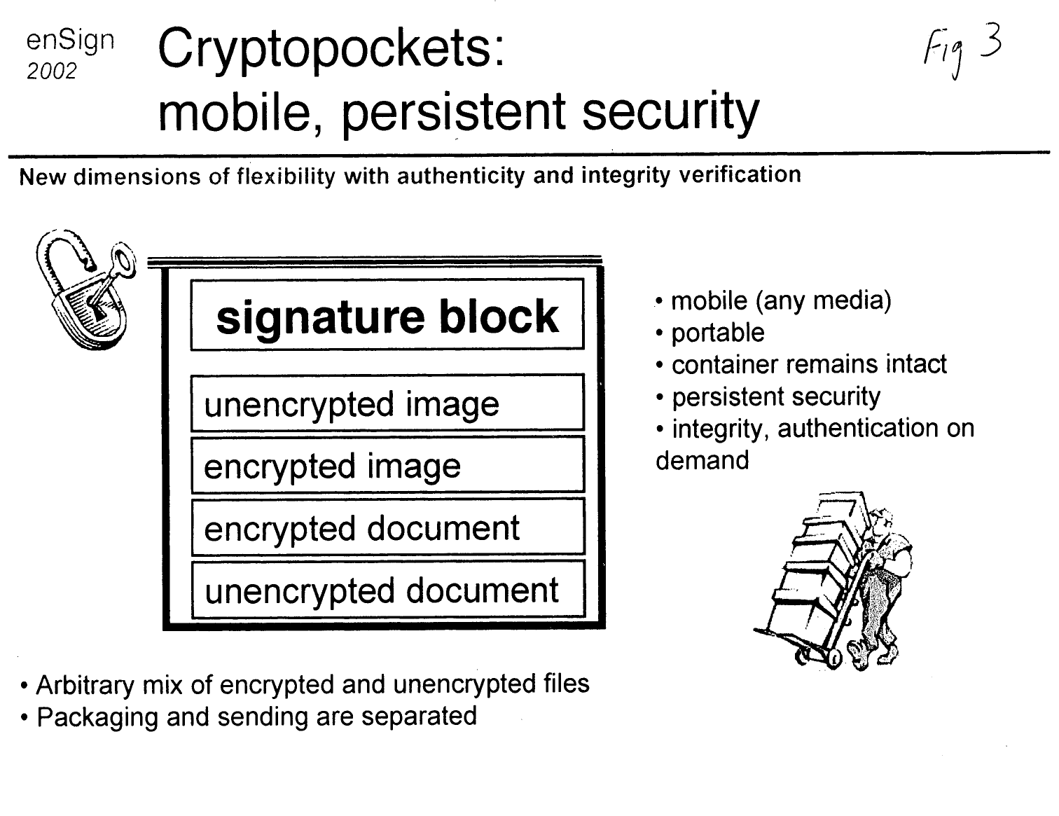

Referring to FIG. 1, a block diagram indicative of a method of providing an electronic file according to a first embodiment of the invention. The diagram shows: a sender computer 101, an Internet link 102 and a recipient computer 103. In use, a user provides a user file and an electronic signature as inputs to a container program on the sender computer 101. The container program encodes the user file and the electronic signature to create a container file. The container file includes executable instructions that are intended to verify the authenticity of the electronic signature. Optionally, the authentication data incorporates time data provided from a trusted, secure time source permitting a verification of the time of origin of the container file. The container file is then provided to the recipient computer 103, for example, as an attachment in a conventional email. The electronic mail propagates from the sender computer 101 to the recipient computer 103 via the Internet 102. The recipient computer 103 receives the email with the attached container file. When the container file is opened it scans itself for any form of tampering. The scanning operation involves ensuring that the recipient computer 103 is using a recognized operating system having a known crypto engine. The executable instructions make use of the crypto engine when the container file scans itself for tampering. For example, the Windows operating system includes a Microsoft Crypto API (Application Programming Interface). In the event that no tampering is detected, the user file is provided along with the electronic signature. When the user file is opened, the electronic signature is acknowledged provided no tampering has been detected. In the event that tampering is detected, the system informs the user that tampering has been detected and inhibits access to the contents of the container file. Thus, the recipient is provided verification that the user file provided is authentic and the recipient is unable to repackage the container. Unlike much of the prior art, the method according to the invention need not automatically provide return information to the sender indicating that the user file has been received. In many applications such verification is unnecessary. For example, a university is likely to be reluctant to provide transcripts to graduates in an electronic format due to anxiety that the transcripts will be modified. Thus, when a potential employer requests a transcript from a student, the student is able to provide a copy of a container file that includes a user file corresponding to their transcript. In this application, the university does not need or necessarily desire confirmation that the potential employer has reviewed the transcript, however, other information provided with the user file optionally provides contact information for the university thereby permitting an additional verification of the transcript. Beneficially, the container file with the transcript is optionally copied and therefore, the university need not issue new container files with the transcript each time a transcript is requested, thereby avoiding delays.

Unlike the related prior art, the container file includes the executable code that is used to determine if the container file has been corrupted. As previously mentioned, the executable code of the container file relies upon a crypto engine in the recipient computer. It is suggested that the crypto engine be a crypto engine provided with the operating system, however this need not be the case. In comparison, a prior art example of a secure system for delivering a file would rely on executable code within a software program present on the recipient computer independent of the delivered file. Unfortunately, this presents some difficulties. For example, as a student providing a transcript to an interested employer it is inconvenient to ensure that the interested employer has the correct software on their computer to verify the authenticity of the transcript. This problem is avoided with the container file according to the first embodiment of the invention because the executable code used to verify the authenticity of the container file is provided with the container file. Another problem with the prior art system is that the software program whose executable code is needed to determine if transcript is authentic may have been compromised. If so, any information provided over the supposedly secure link could be provided illicitly to others, provided the recipient computer has a working network connection or Internet connection.

Clearly, the first embodiment of the invention described above is useful in a wide variety of applications. For example, the authenticity of information provided on the Internet is often questionable however, using this system, it is a simple matter for a user who downloads a file to verify that the information received is authentic and unaltered. Thus, an organization wishing to provide a copy of an official press release is able to do so without fear that their message will be altered. Similarly, an electronic retailer is able to provide an electronic receipt for the purchase of goods and services. Alternatively, a government is able to provide publications in a secure way.

It will be apparent to one of skill in the art that the user file is optionally an encrypted user file when it is provided to the container. Since a large number of different files are optionally stored in a container file it is apparent that optionally some user files are encrypted while others are not. Optionally, different users files provided in a container file have different encryption schemes.

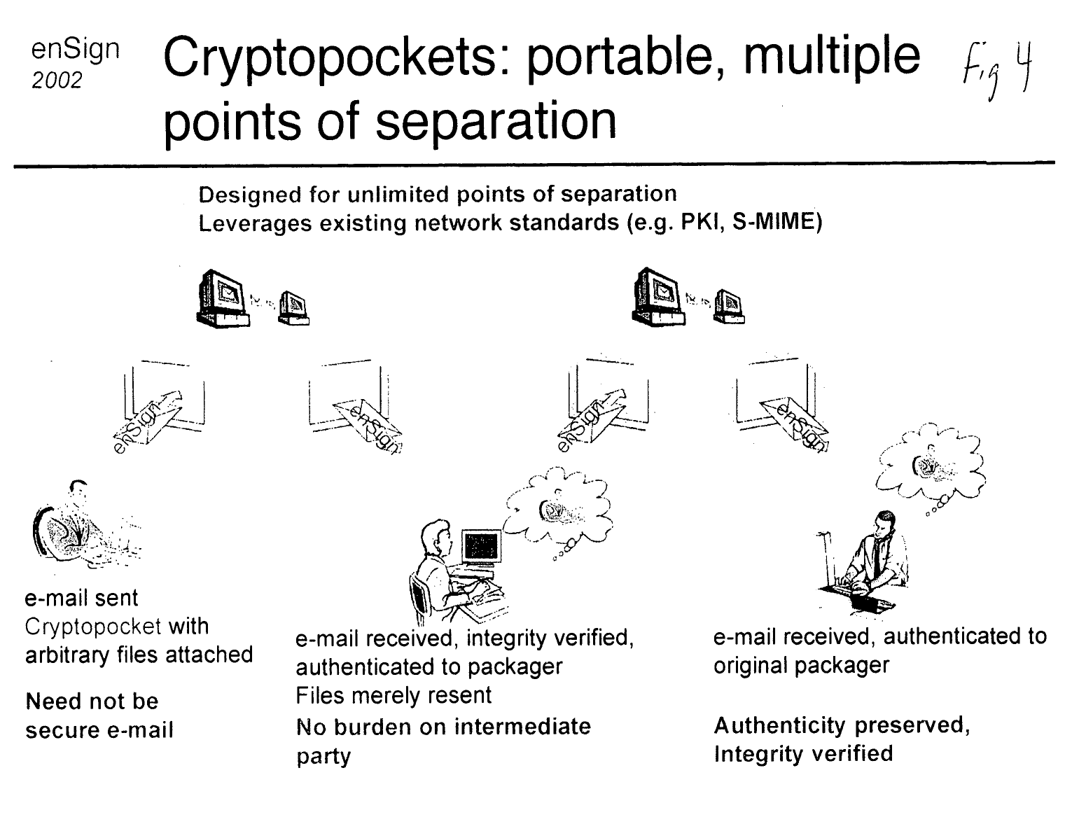

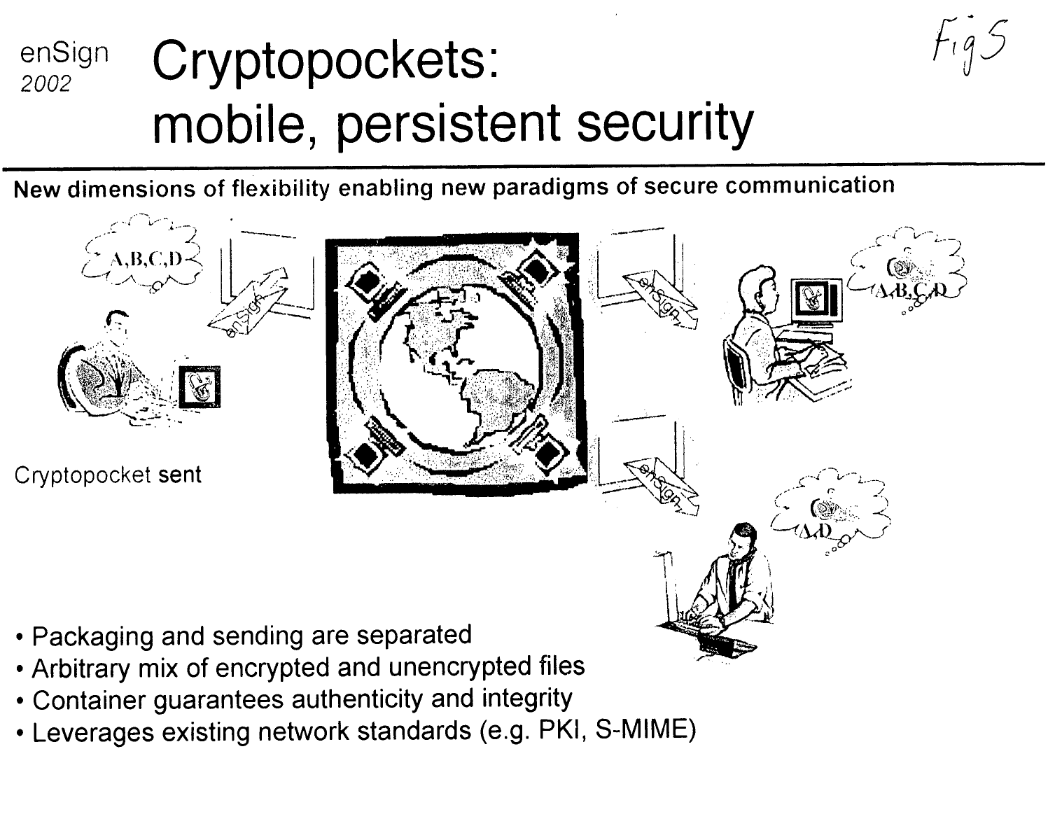

A variety of protection concepts are easily adapted to support enhanced security container files. One such protection concept involves the use of a secure electronic data capsule on the receiver's computer in order to open the container file. Referring to FIG. 2, a schematic diagram according to a second embodiment of the invention is shown. FIG. 2 includes: a sender computer 101, an Internet link 102 and a first recipient computer 103a and a second recipient computer 103b. In use a sender chooses a set of sender files to be sent. Each one of these files has a security level associated with it. Optionally, the sender modifies a security level of a file as needed. The files are encoded along with an electronic signature. Once created, the container file is sent to at least one of the recipient computers 103a and 103b. A first recipient at the first computer 103a opens the container file using a first recipient secure electronic data capsule. When the container file is opened with the first recipient secure electronic data capsule a first set of files from the set of sender files is provided along with the electronic signature. The container file, when activated, provides the secure electronic data capsule as well as the electronic signature to a crypto engine of the operating system of the first recipient computer and then queries the crypto engine and, using results from the query determines if it is likely that the container file has been tampered with. Upon determining that no tampering has occurred, a set of files of the set of sender files is provided to the first recipient. The set of files that is provided is determined by comparing a security level of the first recipient secure electronic data capsule with a security level of each file of the set of sender files. Thus, when the container file is opened using a second recipient secure electronic data capsule, the second recipient secure electronic data capsule having a different security level than the first recipient secure electronic data capsule the container file first checks to ensure that it has not been tampered with, and then, assuming no tampering is detected, provides files from the container consistent with the second recipient secure electronic data capsule security level. In the event that it is determined that the container file has been tampered with, no files are provided. There are numerous ways of providing information from a recipient secure electronic data capsule to the container file. A variety of protection concepts are easily adapted to support enhanced security container files. One such protection concept involves the use of a secure electronic data capsule on the receiver's computer in order to open the container file. For example, the user optionally types data of a secure electronic data capsule much as they would an alphanumeric password. Alternatively, the container file is transferred from an email message to a computer program associated with a given user. The computer program includes a secure electronic data capsule associated with the user as well as data used to assist in verifying the authenticity of electronic signatures associated with container files. The computer program then transfers electronic data associated with the secure electronic data capsule to the container file. Optionally, using a computer featuring a GUI (graphical user interface) a transfer of electronic data associated with the secure electronic data capsule occurs by having the user “drag and drop” the container file onto an icon associated with the computer program. Other approaches for providing electronic data associated with a secure electronic data capsule optionally include, providing a secure electronic data capsule in the form of data from a ROM memory associated with the recipient computer, and providing a secure electronic data capsule in the form of biometric data associated with a specific user. Clearly, a wide variety of options are available for providing a secure electronic data capsule as will be well understood by a person of skill in the art. Indeed, the secure electronic data capsule is used very much like an electronic key, the meaning of which will be well understood by a person of skill in the art.

Thus, the second embodiment of the invention is useful in a variety of tasks. For example, the second embodiment of the invention is useful for providing military instructions in which different individuals having different duties are provided with different tasks. The instructions for a military operation are provided in files along with a electronic signature to form a container file. When an individual wishes to know their instructions, they simply open the container file with their recipient secure electronic data capsule. If one individual loses their container file they may optionally obtain a copy from anyone else having a copy of the container file. Although the container files are identical, the instructions they provide vary in accordance with the tasks of the individuals who open the container file.

Additionally, the second embodiment of the invention is highly beneficial for other tasks. For example, it is well suited to providing a software patch for a set of related software programs. Consider a company that produces, for example, a spreadsheet program. The company markets a variety of spreadsheet programs that share a core set of features. The more costly versions of the program support more complex features. The company produces a patch for their software. A user obtains a copy of the patch, for example via the Internet, and executes it. The patch queries the computer for the spreadsheet software and upon finding it, determines the version of the software and the supported features. The patch verifies its authenticity. The patch then updates files that are consistent with the version and features of the spreadsheet software. This method is highly advantageous for a variety of reasons. The user is able to download the patch from any source because the container file is secure. In the event that the container has been tampered with then the user is informed and the patching process is optionally aborted. Additionally, one patch is optionally used to update a variety of programs. This helps to reduce the likelihood of a user becoming confused with regards to which patch is needed to update their software. Additionally, the software patch is platform independent. Thus, if the spreadsheet is, for example, a platform-independent java application, the patch provided according to either embodiment of the invention will permit proper upgrading of the spreadsheet. It should be noted that the container files described with reference to either of the first and second embodiments of the invention are not unlike other computer files.

They are easily stored on a variety of storage media that are ordinarily used to store electronic files, such as: hard disc drives, PROM chips, CD-Roms and memory sticks to name a few.

Various Applications

Providing receipts for banking transactions and Internet transactions

Providing secure information to critical services, for example, a photo of a criminal is easily circulated when the authenticity of the photo is easily established.

Providing official documentation, such as a press release.

Providing official documentation, such as an employee statement of income paid over a specific period, for example, for income tax purposes.

Maintaining secure records, for example, keeping medical data records associated with care provided to a patient.

Table 1, shown below provides a list of some likely applications for an electronic file according to the invention.

TABLE 1

| IDENTIFIER | SITUATION | SOLUTION |
|---|---|---|
| Homeowner | Want to create indisputable | Create spreadsheet of contents, digital camera |
| | record of home contents for | jpegs and seal them in a container file according to |
| | insurance purposes | an embodiment of the invention |
| Insurance | Want to reduce incidence of | Recommend clients seal their documentation of |
| Company | fraudulent and exaggerated | household contents in a container file according to |
| | claims when fires or burglaries | an embodiment of the invention. Offer discounts |
| | occur | and expedite claims. |
| Writer | Want to send out that piece | Electronically seal your work in a container file |
| | you've written but are concerned | according to an embodiment of the invention prior to |
| | with protecting your undisputed | sending. Keep a copy if you ever need to prove the |
| | authorship | work was yours with an electronic signature and |
| | | date stamp. |
| Publisher | Want your authors to warrant that | Have authors send their final copy together with a |
| | a specific piece of work is their | statement that this work is original in a container file |
| | own, without any ambiguity in the | according to an embodiment of the invention. Both |
| | future, to exonerate you of any | parties will have indisputable electronic copies of the |
| | potential claims | material. |
| Estate Planner | Want a copy of your will to be | Seal your will with a scanned copy of your signature |
| | clearly authenticated to you and | and witnesses' attestations in a container file |
| | available to all your future | according to an embodiment of the invention. |
| | beneficiaries | Distribute freely. |
| Enterprise | Want to save money on | Seal an electronic copy of your annual report in a |
| | producing your annual report yet | container file according to an embodiment of the |
| | adding the benefit of clear | invention. Distribute to investment analysts and |
| | authentication to your company | invite them to copy as they see fit. |
| Enterprise | Want to avoid others' | Have a policy that all press releases will be |
| | misrepresentation of your | distributed in a container file according to an |
| | sensitive public information | embodiment of the invention, authenticated to your |
| | | PR or Marcom professional. You will always be |
| | | able to prove what you wrote rather than what |
| | | someone else printed. |
| Health Practitioner | Want to make sure patients' | Seal the relevant record with a digital image of the |
| | records or other vital information | patient in a container file according to an |
| | is not altered and not confused | embodiment of the invention digitally signed by or |
| | with someone else | including scanned signature of the relevant health |
| | | care professional |
| Hotels | Want unambiguous confirmation | Seal your room reservation information in a |
| | of your customers' reservations; | container file according to an embodiment of the |
| | want to avoid unauthorized | invention and distribute to your customer. File |
| | “copies” of reservations with an | electronic copy yourself. |
| | altered price, room, etc. | |
| Hotel Patrons | Want unambiguous confirmation | Have your hotel send you the information in a |
| | of your reservations; want to | container file according to an embodiment of the |
| | avoid misunderstandings with an | invention. Bring a CD or floppy with your relevant |
| | altered price, room, etc. | information at check-in time. |
| Private | Have burden to provide report | Seal your report in a container file according to an |
| Investigator | and want to capture records that | embodiment of the invention. Electronically store as |
| | can't later be challenged or | many copies as you need in multiple locations. |
| | revised | |
| Home Inspector | Want to produce electronic | Seal your report in a container file according to an |
| | reports but are concerned that | embodiment of the invention. Electronically store a |
| | your report could be altered after | copy for yourself and give copy to recipient and real |
| | the fact, which could reflect badly | estate agent. |
| | on you | |
| Small To Medium | Want to enter into simple | Seal your agreement together with a scanned copy |
| Sized Enterprise | agreements with others that can't | of every party's signature in a container file |
| | later be disputed, want to avoid | according to an embodiment of the invention. |
| | legal expense | Distribute to all parties. |
| Cfo | Have burden to send financial | Seal your financial information in a container file |
| | information to CEO/executive | according to an embodiment of the invention. |
| | team and want to capture records | |
| | for audit purposes that can't later | |
| | be challenged | |
| Small To Medium | Want to send quotes | Seal quotes in a container file according to an |
| Sized Enterprise | electronically with a non- | embodiment of the invention. Electronically store |
| | repudiable time stamp | your copy and send copy to recipient. |
| Enterprise Or | Want to send request for proposal | Seal your RFP in a container file according to an |
| Government | electronically, and want to ensure | embodiment of the invention. Keep an electronic |
| Agency | that this request can't be altered | copy and distribute freely. |
| | by any other party and want a | |
| | non-repudiable time stamp | |
| Enterprise | Want to reduce amount of paper | Seal your records in a container file according to an |
| | for various records but need to | embodiment of the invention. If multiple signatures |
| | maintain signed copies for audit | are required, scan a signed signature page and |
| | purposes | include in the container file. Store multiple copies in |
| | | safe places. |
| Inventor | Want records of your work with | Seal your intellectual property in a container file |
| | indisputable time stamps | according to an embodiment of the invention. Keep |
| | | multiple copies in safe places. The electronic |
| | | signature and time stamp will prove the dates of |
| | | your claims. |
| HR Or Manager | Want performance or promotion | Seal records in a container file according to an |
| | records to be electronic, but need | embodiment of the invention. Electronically file in |
| | signed copy | multiple secure locations |
| Finance | Want to avoid paper pay stubs for | Produce electronic pay stubs in a container file |
| Department | direct deposit | according to an embodiment of the invention. |
| | | Distribute to employees and electronically file |
| | | yourself. |
| E-Businesses | Want record of transactions that | Seal the transaction details in a container file |
| | doesn't “evaporate” once the | according to an embodiment of the invention and |
| | secure connection ends | ensure both parties have a copy. |
| Critical Security | Need to send authenticated | Seal all relevant material with different clearance |
| | critical images or instructions with | levels in a container file according to an |
| | multiple levels of clearance | embodiment of the invention. Electronically file copy |
| | | for yourself and distribute freely to all intended |
| | | recipients, independent of clearance level. |
| Airport Security | Need to send authenticated | Seal all images in a container file according to an |
| | critical images (e.g. Terrorists) | embodiment of the invention. Electronically file copy |
| | which airport security staff will | for yourself and distribute freely to all staff. |
| | trust | |
| Universities | Want to issue authenticated | Seal copy of diploma and transcript in a container |
| | transcript which future employers | file according to an embodiment of the invention. |
| | will trust | Sell copy to student which student can distribute |
| | | freely. Employer has confidence student could not |
| | | have tampered with files. |
| Universities | Want to be able to trust foreign | Seal transcripts or TOEFL tests with picture of |
| | transcripts, TOEFL results, etc. | student in a container file according to an |
| | Many foreign students do “bait | embodiment of the invention in foreign country. |
| | and switch”. | Send to university in Canada or U.S. |

Numerous other embodiments of the invention will be apparent to one of skill in the art. For example, when the container file is executed a set of instructions is optionally implemented that causes the original container file to be erased thereby eliminating the original container file. Alternatively, since the executable code associated with verification of the authenticity of the container file is provided in the container file the responses associated with results indicative of either tampering or an absence thereof exist within the container file. For example, if tampering is detected, the container file optionally determines if the recipient computer has an Internet connection and, if so, it provides an electronic message to another computer indicating that it has been tampered with and, for example, data associated with the originator of the container file. Clearly, a wide variety of different responses are available for results indicative of tampering or no tampering.

1. A method of creating a container file and providing the container file from a sender to a recipient, the method comprising:
providing a computer associated with the sender;
using the computer associated with the sender to encode at least a file to provide an encoded file, the encoded file for when accessed
executing instructions provided with the encoded file, the instructions for verifying that a portion of data within the encoded file has not been modified;
upon successful verification, executing at least an instruction from a first list of instructions; and;
upon unsuccessful verification, executing at least an instruction from a second list of instructions; and,
providing the encoded file to at least a recipient.

2. A method according to claim 1, comprising: using the computer associated with the sender to store the encoded file.

3. A method according to claim 2, wherein in the step of using the computer associated with the sender to store the encoded file, the encoded file is stored in a hard disk drive of the computer associated with the sender.

4. A method according to claim 1, comprising the step of storing the encoded file in a non-volatile storage media.

5. A method according to claim 4, wherein in the step of storing the encoded file in a non-volatile storage media, the encoded file is stored in a programmable read-only memory chip.

6. A method according to claim 4, wherein in the step of storing the encoded file in a non-volatile storage media, the encoded file is stored in compact disc also referred to as a CD-Rom.

7. A method according to claim 4, wherein in the step of storing the encoded file in a non-volatile storage media, the encoded file is stored in a DVD disc.

8. A method according to claim 4, wherein in the step of storing the encoded file in a non-volatile storage media, the encoded file is stored in a smart card.

9. A method according to claim 4, wherein in the step of storing the encoded file in a non-volatile storage media, the encoded file is stored in a floppy disc.

10. A method according to claim 1, wherein the step of executing at least an instruction from a first list of instructions involves providing a file of the at least a file and executing at least an instruction from a second list of instructions involves other than providing a file of the at least a file.

11. A method according to claim 1, comprising generating authentication data and, wherein the step of verifying comprises comparing data derived from at least an electronic signature encoded within the encoded file with the authentication data.

12. A method according to claim 11, wherein the authentication data is generated after of step of querying a crypto engine provided with an operating system associated with a computer that performs the step of verifying.

13. A method according to claim 12, wherein the operating system is a Windows operating system and the crypto engine is a Microsoft CryptoAPI engine.

14. A method according to claim 12, wherein the operating system is a Linux based operating system and the crypto engine is provided in the Linux based operating system.

15. A method according to claim 12, wherein the operating system is a Unix based operating system and the crypto engine is provided in the Unix based operating system.

16. A method according to claim 12, wherein the operating system is a Macintosh OS operating system and the crypto engine is provided in the Macintosh OS operating system.

17. A method according to claim 12, wherein the operating system supports Java and the crypto engine is a Java crypto engine.

18. A method according to claim 11, wherein the encoded file includes chronological data obtained from a secure third party.

19. A method according to claim 11, comprising the steps of executing the encoded file after it is received by the recipient and deleting the encoded file automatically during the execution of the encoded file.

20. A method of creating a container file and providing the container file from a sender to a recipient, the method comprising:
providing a computer associated with the sender;
using the computer associated with the sender to encode at least a file to provide an encoded file, each file of the at least a file having a security clearance value associated therewith, the encoded file for when accessed
receiving a secure electronic data capsule associated with a security clearance value of a user;
executing instructions providing with the encoded file, the instructions for verifying that a portion of data within the encoded file has not been modified;
upon successful verification, executing at least an instruction from a first list of instructions; and;
upon unsuccessful verification, executing at least an instruction from a second list of instructions; and,
providing the encoded file to at least a recipient.

21. A method according to claim 20, wherein in the step of using the computer the secure electronic data capsule is an electronic key.

22. A method according to claim 20, comprising: using the computer associated with the sender to store the encoded file.

23. A method according to claim 22, wherein in the step of using the computer associated with the sender to store the encoded file, the encoded file is stored in a random access memory of the computer associated with the sender.

24. A method according to claim 22, wherein in the step of using the computer associated with the sender to store the encoded file, the encoded file is stored in a hard disk drive of the computer associated with the sender.

25. A method according to claim 20, comprising the step of storing the encoded file in a non-volatile storage media.

26. A method according to claim 25, wherein in the step of storing the encoded file in a non-volatile storage media, the encoded file is stored in a programmable read-only memory chip.

27. A method according to claim 25, wherein in the step of storing the encoded file in a non-volatile storage media, the encoded file is stored in a compact disc also referred to as a CD-Rom.

28. A method according to claim 25, wherein in the step of storing the encoded file in a non-volatile storage media, the encoded file is stored in a DVD-Rom of the computer associated with the sender.

29. A method according to claim 20, wherein the operating system is a Linux based operating system and the crypto engine is provided in the Linux based operating system.

30. A method according to claim 20, wherein the operating system is a Unix based operating system and the crypto engine is provided in the Unix based operating system.

31. A method according to claim 20, wherein the operating system is a Macintosh OS operating system and the crypto engine is provided in the Macintosh OS operating system.

32. A method according to claim 20, wherein the operating system supports Java and the crypto engine is provided in the Java operating system.

33. A method according to claim 20, wherein the step of executing at least an instruction from a first list of instructions involves providing a file of the at least a file having a security clearance consistent with the received secure electronic data capsule and, executing at least an instruction from a second list of instructions involves other than providing a file of the at least a file.

34. A method according to claim 20, comprising: using the computer associated with the sender to store the encoded file.

35. A method according to claim 20, comprising generating authentication data and, wherein the step of verifying comprises comparing data derived from at least an electronic signature encoded within the encoded file with the authentication data.

36. A method according to claim 35, wherein the encoded file includes chronological data obtained from a secure third party.

37. A method according to claim 35, comprising the steps of executing the encoded file after it is received by the recipient and deleting the encoded file automatically during the execution of the encoded file.

38. A method of creating a container file and providing the container file from a sender to a recipient, the method comprising:
providing a computer associated with the sender;
using the computer associated with the sender to encrypt at least a file to provide an encoded file, each file of the at least a file having a security clearance value associated therewith, the encoded file for when accessed
receiving a secure electronic data capsule associated with a security clearance value of a user;
executing instructions providing with the encoded file, the instructions for verifying that a portion of data within the encoded file has not been modified;
upon successful verification, decrypting a file of the at least a file, and;
upon unsuccessful verification, executing at least an instruction from a second list of instructions; and,
providing the encoded file to at least a recipient.

39. A method according to claim 38, wherein in the step of using the computer the secure electronic data capsule is an electronic key.

40. A method according to claim 38, comprising: using the computer associated with the sender to store the encoded file.

41. A method according to claim 40, wherein in the step of using the computer associated with the sender to store the encoded file, the encoded file is stored in a random access memory of the computer associated with the sender.

42. A method according to claim 40, wherein in the step of using the computer associated with the sender to store the encoded file, the encoded file is stored in a hard disk drive of the computer associated with the sender.

43. A method according to claim 38, comprising the step of storing the encoded file in a non-volatile storage media.

44. A method according to claim 43, wherein in the step of storing the encoded file in a non-volatile storage media, the encoded file is stored in a programmable read-only memory chip.

45. A method according to claim 43, wherein in the step of storing the encoded file in a non-volatile storage media, the encoded file is stored in a compact disc also referred to as a CD-Rom.

46. A method according to claim 43, wherein in the step of storing the encoded file in a non-volatile storage media, the encoded file is stored in a DVD-Rom of the computer associated with the sender.

47. A method according to claim 38, wherein the operating system is a Linux based operating system and the crypto engine is provided in the Linux based operating system.

48. A method according to claim 38, wherein the operating system is a Unix based operating system and the crypto engine is provided in the Unix based operating system.

49. A method according to claim 38, wherein the operating system is a Macintosh OS operating system and the crypto engine is provided in the Macintosh OS operating system.

50. A method according to claim 38, wherein the operating system supports Java and the crypto engine is provided in the Java operating system.

51. A method according to claim 38, wherein the step of executing at least an instruction from a first list of instructions involves decrypting a file of the at least a file having a security clearance consistent with the received secure electronic data capsule and, executing at least an instruction from a second list of instructions involves other than decrypting a file of the at least a file.

52. A method according to claim 38, comprising: using the computer associated with the sender to store the encoded file.

53. A method according to claim 38, comprising generating authentication data and, wherein the step of verifying comprises comparing data derived from at least an electronic signature encoded within the encoded file with the authentication data.

54. A method according to claim 53, wherein the encoded file includes chronological data obtained from a secure third party.

55. A method according to claim 53, comprising the steps of executing the encoded file after it is received by the recipient and deleting the encoded file automatically during the execution of the encoded file.
